(19) United States
(12) Patent Application Publication
(10) Pub. No.: US 2026/0262629 A1
(43) Pub. Date: Sep. 10, 2026

(54) A NON-LETHAL USE AND METHOD FOR HERD PROTECTION

(71) Applicant: fenaco Genossenschaft, Bern (CH)

(72) Inventors: Davide STAEDLER, Comano (CH); Federico TETTAMANTI, Lodano (CH); Fiorella LUCARINI, Sezze (IT)

(73) Assignee: fenaco Genossenschaft, Bern (CH)

(21) Appl. No.: 19/167,096

(22) PCT Filed: Mar. 14, 2024
(86) PCT No.: PCT/EP2024/056878

§ 371 Date: Sep. 19, 2025

(30) Foreign Application Priority Data
Mar. 21, 2023 (EP) 23163167.2

(51) Int. Cl. A01M 29/12; A01K 27/00

(52) U.S. Cl. CPC A01M 29/12; A01K 27/001

(57) ABSTRACT

The invention relates to a collar for cattle or livestock, for the purpose of acting as a means of protection against possible attacks by wolves, foxes or other predators of said cattle or livestock; the cattle or livestock collar incorporates volatile odors selected from the group consisting of specific pheromones, allomones or kairomone compounds which disperse or scatter said predators.

### FIELD OF THE INVENTION

The invention relates to the use of a collar for cattle or livestock, in order to serve as a means of protection against possible attacks of wolves, foxes or other predators of said cattle or livestock, the collar for cattle being incorporating volatile pheromone compounds or similar odorous substances of artificial origin that emit odor that scatters or disperses said predators.

### BACKGROUND OF THE INVENTION

From practically the beginning of recorded history man has sought ways to eliminate predators that prey on his livestock.

In the past, lethal methods were the preferred choice. However, with increased awareness of the need for biodiversity conservation, new management methods focus on non-lethal control, with emphasis on exploiting aspects of naturally occurring organismal behaviors and ecology. Over the past decade, technological advances in extraction method's and equipment have also developed new techniques providing a broader range of information about species biology for management use.

The wolf has been recolonizing the Alps from the remaining Italian population (Valière et al. 2003). The first wolves to return to the Alps after their extirpation by man appeared around 1994 in the French Alps (Louvrier et al. 2018). Over the years, they have moved on to cover all the Alps. Today, we have new wolf packs in the Alps every year, and conflicts with humans activity are increasing. Conflicts between man and predator have always been the order of the day, and politics must provide immediate and concrete answers.

Specifically, the problem brought about by the recolonization of the wolf or other predators is the conflicts with domestic animals and predation occurring during the alpine pasture period, when sheep and goats are often left unattended in the wild. Farmers and alpine managers are equipping themselves with guard dogs, which are strongly encouraged and with electric fences that can reduce wolf predation.

Other solutions or products specially developed for this purpose are also used, which, however, are usually expensive and of high economic cost, since in most cases they are based on electronic devices and instruments, sophisticated audio-visual and/or computer systems that require complex technologies.

However, recent work often means that the alps or farms on the plains cannot be protected. So the losses that occur in these pastures and the guarded ones are counted towards the eventual culling of the wolf or wolves guilty of preying on sheep or goats (Swiss Federal Office for the Environment).

To date, the solutions that have been tried to achieve coexistence between wolves and mountain agriculture are not sufficient, and the solution that is increasingly being put forward is the culling of problematic wolves. The same also occurs for lynx, bears, lions, tigers, jaguars, cougars, foxes or other large predators around the world.

The culling of wolves or other predators is not a suitable solution for the conservation of the species. Non-lethal methods could be more functional and profitable. Moreover, the biology of the animal causes it to self-regulate once it has reached its maximum state of individuals. Recent studies show that populations and packs of wolves managed by hunting show very high levels of glucocorticoids, indicating a high rate of stress (Bryan et al. 2015). It is also known that individuals under high stress can change their behaviour, and in a highly social species like wolves, this can have significant repercussions on pack life (Bryan et al. 2015). In addition, stress hormones can impede reproduction.

The development of non-lethal methods of protection could undoubtedly have positive aspects for wolf conservation in the Alps or other predators too. The development of non-lethal systems to prevent predation is positively favorable for predator-human interaction and the whole biodiversity. Nonlethal approaches to managing predation could be an important step to increase acceptance of large mammalian predators (Shivik et al. 2003).

The wolf is a highly social animal that lives in packs. It has a variety of visual behaviours, but chemical signals (pheromones) are predominant. The pheromones are naturally released by an organism to modulate the behaviour and/or physiology of conspecifics (Karlson & Lüscher 1959). State signalling with the aid of pheromones has consistently been underestimated in inter- and intra-specific interactions. In particular, when marking the territory of a herd with urine, several volatile compounds are released that are essential for signalling the presence of a pack. This is also true for other predators' species.

Research demonstrated as bio fencing effectively manipulated the movements of wolves promoting to reducing human-wildlife conflict (Anhalt et al. 2014; Ausband et al. 2013; Wolfram 2013). But all this research was with pheromones always placed on the ground thus causing them to degrade quickly and lose their effective functionality.

US 2017/006861 A1 (BOVIO JEFFERY [US] ET AL) discloses a paper product that includes an article of paper, a binding agent disposed on a surface of the article of paper, and an animal-affecting substance. The animal-affecting substance is bound to the strip of paper via the binding agent and the paper is in a twisted cord configuration such that the animal-affecting substance is disposed within an interior defined by the article of paper.

In US 2017/013833 A1 (SHIELDS EDGAR PAUL [US]) a proactive repellent and camp perimeter defense against apex predators is provided. In an implementation, the proactive repellent is a liquid agent or aerosol tuned to the sensitive olfactory senses of apex predators. Ingredients catch the attention of the apex predator, while also providing olfactory aversion signals. The example repellent can be applied around an area to be proactively protected via delivery methods such as spray, aerosol, gel, or stream apparatuses, or by foam, cloth, gauze, sponge, wick, or swab applicators. The repellent then dries, emitting repellent odors and chemicals in both liquid and dried states. The example repellent may be pre-applied to artifacts, such as string, cord, or ribbon for surrounding a campsite, or on cards, tubes, sticks, balls, granules, and stakes. An example device may be worn by a hiker as a cartridge, nodule, capsule, aerator, or fabric evaporator, and then reused by rewetting with the example repellent.

U.S. Pat. No. 4,338,886 A (MCBRIDE ROY T.) discloses a predator control collar (10) including a pair of toxic filled pouches (12) and (14) attached to elastic straps (16) and (18) for expansion. The pouches (12) and (14) include a fill plug (22) for a needle to inject a liquid predicide into the pouches. The pouches (12) and (14) are positioned about the elastic straps (16) and (18) so that they are maintained in the general region below the ear of the livestock, and the straps (16) and (18) are of sufficient elasticity to expand with the increase in the size of the animal's neck as it grows to full maturity.

ES 1180313U (GONZALEZ FERNANDEZ DIONISIO) provides a protective collar for livestock, mainly sheep or goat cattle, characterized by comprising an adjustable ring (2) provided with a housing (3) able to incorporate at least one element (4) that gives off odor, for example a tablet impregnated of a volatile substance that scavenges wolves and foxes, said housing (3) being provided with lateral slots (5) that allow the exit of said odor, as well as a cover (6) to close it and access it to place or extract said element (4).

The major problem with the use of these protective collars for livestock is to be able to keep the volatile substance that scavenges predators long enough over time while releasing them over a prolonged period and in sufficient quantity for them to be effective but without this becoming too expensive and requiring them to be replaced too often. Slow delivery is therefore one key aspect of the present invention.

The development of effective antipredation tools would clearly have a positive effect on predators conservation, and if one can develop effective techniques centered around methods designed to deter depredation of livestock using non-lethal methods, we impact not only human relations with predators, but aid biodiversity conservation as whole.

### BRIEF DESCRIPTION OF THE INVENTION

In the present invention, Applicants proposed the development of a non-lethal system for herd or livestock protection. The invention is based on the selection of chemical compounds present in the urine of wolves or other predators to be used as biological fences. The present invention includes the selection and synthesis of these molecules and/or structurally related molecules, and their application on physical supports (collars). Collars suitable to be loaded with these compounds have been carried out and applied to livestock (sheep, cows, goats, etc.) in order to create biological borders that enclose each pet or animal. Compounds loaded in the collars are released gradually as volatile compounds, acting as a natural indicator of the presence of a new “dummy” pack for example to the wolves already in the area or passing wolves. Before the test in real conditions, it has been necessary to evaluate its functionality in captive wolves to test and calibrate the collars. The final result is a collar containing pheromones that can then be tested in suitable locations.

Prior art attempts were always using pheromones placed on the ground thus causing them to degrade quickly and lose their effective functionality in the contrary the present invention proposes to use pheromones directly on livestock.

One of the objects of the present invention is the use of a protective collar or any convenient support mean for cattle or livestock, to serve as a means of protection against possible attacks of predators of said cattle or livestock, the protective collar being incorporating at least one desired volatile odor that scatters or disperses said predators, said desired volatile odor being selected from the group consisting of specific pheromones compounds that emit odor that scatters or disperses said predators, characterized in that said protective collar comprises a hydrophobic matrix impregnated with said at least one desired volatile odor that scatters or disperses said predators said hydrophobic matrix further comprising antioxidants and/or ionic or non-ionic surfactants, used as emulsifiers and stabilizers, wherein said hydrophobic matrix is coated with a hydrophobic polymer for the structure and mounted on a collar or any convenient support mean to be applied to said cattle or livestock to form the protective collar, and whereas said desired volatile odor that scatters or disperses said predators are territorial sex pheromones specific to said predators' species.

Another object of the present invention is to provide a non-lethal method for cattle or livestock protection comprising the step of applying a protective collar or any convenient support mean to said cattle or livestock, to serve as a means of protection against possible attacks of predators of said cattle or livestock, the protective collar or any convenient support mean being incorporating at least one desired volatile odor that scatters or disperses said predators, said desired volatile odor being selected from the group consisting in pheromone compounds that emit odor that scatters or disperses said predators, characterized in that said protective collar or any convenient support mean comprises a hydrophobic matrix impregnated with said at least one desired volatile odor that scatters or disperses said predators said hydrophobic matrix further comprising antioxidants and/or ionic or non-ionic surfactants, used as emulsifiers and stabilizers, wherein said hydrophobic matrix is coated with a hydrophobic polymer for the structure and mounted on a collar or any convenient support mean to be applied to said cattle or livestock to form the protective collar, and whereas said desired volatile odor that scatters or disperses said predators are territorial sex pheromones specific to said predators' species.

Other objects and advantages of the invention will become apparent to those skilled in the art from a review of the ensuing detailed description, which proceeds with reference to the following illustrative drawings, and the attendant claims.

### BRIEF DESCRIPTION OF THE FIGURES

FIG. 1: shows the number of times wolves crossed the door with (YES) and without (NO) pheromones.

FIG. 2: illustrates the number of times wolves ate on the new food place with (YES) and without (NO) pheromones.

FIG. 3: illustrates a scheme of a support according to the invention.

### DETAILED DESCRIPTION OF THE INVENTION

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting. In the case of conflict, the present specification, including definitions, will control.

Unless defined otherwise, all technical and scientific terms used herein have the same meaning as is commonly understood by one of skill in art to which the subject matter herein belongs. As used herein, the following definitions are supplied in order to facilitate the understanding of the present invention.

Throughout this specification, unless the context requires otherwise, the word “comprise” or variations such as “comprises” or “comprising”, will be understood to imply the inclusion of a stated integer or group of integers but not the exclusion of any other integer or group of integers The term “comprise” is generally used in the sense of include, that is to say permitting the presence of one or more features or components.

As used in the specification and claims, the singular forms “a”, “an” and “the” include plural references unless the context clearly dictates otherwise.

One of the object of the present invention lies in the use of a collar for cattle or livestock, mainly sheep, cow, calf or goat, in order to serve as a means of protection against possible attacks of wolves, foxes or other predators of said cattle or livestock, the collar for cattle being incorporating volatile odors being selected from the group consisting of specific pheromones, compounds selected among “territorial sex pheromones” or similar odorous substances of artificial origin that emit odor that scatters or disperses said predators.

In particular the invention provides for the use of a protective collar for cattle or livestock, designated to serve as a means of protection against possible attacks by predators, the protective collar comprises a hydrophobic matrix impregnated with at least one desired volatile odor that deters predators which is coated with a hydrophobic polymer for structural integrity, the protective collar when applied to cattle or livestock forms an effective protective barrier, characterized in that the hydrophobic matrix includes antioxidants and/or ionic/non-ionic surfactants and wherein the at least one desired volatile odor consists of territorial sex pheromones specific to the predator species.

Predation and predator avoidance are strong selective agents. Any heritable character that allows an individual of a prey population to better evade its predators will be represented in greater numbers in later generations. Likewise, traits that allow a predator to more efficiently locate and capture its prey will lead to a greater number of offspring and an increase in the commonness of the trait within the population. Such ecological relationships between specific populations lead to adaptations that are driven by reciprocal evolutionary responses in those populations. Species have evolved numerous mechanisms to escape predation and herbivory. Defenses may be mechanical, chemical, physical, or behavioral.

Many animals produce or obtain chemical defenses from plants and store them to prevent predation.

Predator-prey relationships provide an excellent opportunity to study coevolved adaptations. Decades of theoretical and empirical research have illuminated the various behavioral adaptations exhibited by prey animals to avoid detection and capture, and recent work has begun to characterize physiological adaptations, such as immune reactions, metabolic changes, and hormonal responses to predators or their cues.

Mateo Jill M. et al. “Ecological and hormonal correlates of antipredator behavior in adult Belding's ground squirrels (Spermophilus beldingi)”, doi: 10.1007/s00265-007-0436-9, has demonstrated that the lower corticoids likely reflect that predation risk at this closed site is predictable, and might allow animals to mount large acute cortisol responses, facilitating escape from predators and enhanced vigilance while also promoting glucose storage for the approaching hibernation. Collectively, these data demonstrate that local environments and perceived predation risk influence not only foraging, vigilance, and antipredator behaviors, but adrenal functioning as well, which may be especially important for obligate hibernators that face competing demands on glucose storage and mobilization.

One aim of the present invention is therefore to develop an improved type of protection for animals which offers a practical, efficient and economically low cost solution by using substances that scare away predators, taking advantage of the fact that, there are different types of substances, either present in nature or obtained by chemical processes in industry, which give off certain odors that, for some species are totally repulsive and chase them away, while for others they are absolutely innocuous.

In particular, volatile substances such as pheromones that give off some smell will scare away such predators but that are innocuous for the animal/livestock carrying the collar.

A “pheromone” is a secreted or excreted chemical factor that triggers a social response in members of the same species. Pheromones are chemicals capable of acting like hormones outside the body of the secreting individual, to impact the behavior of the receiving individuals. There are alarm pheromones, food trail pheromones, sex pheromones, and many others that affect behavior or physiology. Pheromones are used from basic unicellular prokaryotes to complex multicellular eukaryotes. Common chemical characteristics of pheromones include being volatile, hydrophobic, and having a low molecular weight.

Pheromones aren't the same as hormones, though the names sound similar. Hormones are chemical messengers such as oestrogen, cortisol, and testosterone. They work inside the body to control things such as growth, mood, and sexual function. Pheromones work outside the body. They act like signals to members of the same species. Animals release pheromones to mark their territory, find prey, attract a mate, or recognize other members of the same species.

In particular, volatile odors of interest are selected from the group consisting in pheromones, compounds selected among “territorial sex pheromones” or similar odorous substances of artificial origin that emit odor that scatters or disperses predators.

Territorial pheromones mark an animal's territory and communicate with other animals for which the area is spoken. They are used to defend an animal's territory from encroachment by others. Territorial pheromones are also sometimes used to mark trails so other members of the same species can find their way around. When animals produce territorial pheromones, they deposit them onto objects in their environment, such as rocks or trees. Other animals that come into contact with these objects will then pick up the territorial pheromone's scent and identify that another animal claims the area. As explained above, territorial pheromones are used by many animals to mark their territory. For example, dogs and cats often urinate on specific areas to mark their territory, and the pheromones in the urine signal to other animals that the territory is claimed. This can help to prevent conflicts and fights over resources.

Preferably said territorial sex pheromones are based on the predator urinary components originating from the specific predator for which repelling is desirable. For example, it can be territorial sex pheromones based on urine extracts from alpha males or pregnant females.

“Volatile odors” according to the present invention are volatile organic compounds (VOCs) that are organic compounds having a high vapor pressure at room temperature. High vapor pressure correlates with a low boiling point, which relates to the number of the sample's molecules in the surrounding air, a trait known as volatility. VOCs are responsible for the odor of scents and perfumes as well as pollutants. In respect to the present invention, VOCs play an important role in communication between animals, e.g. attractants, protection from predation, and even inter-plant interactions.

Preferably, the following territorial sex pheromones are of particular interest to the invention and correspond to the following predator species/families:
Lynx (Lynx lynx, Lynx canadensis): Eurasian lynx, Canada lynx: 3-Hydroxy-3-methylpentan-1-ol; (5R,6S)-6-Acetoxy-5-hexanone; 2-phenylethylamine and 3-methylindole.
Polar bear (Ursus maritimus): Dimethyl trisulfide; 3-methylpentan-1-ol.

Jackals use scent marking to communicate territorial boundaries.

Pheromone compounds includes 2-sec-butyl-4,5-dihydrothiazole.
Golden Jackal (Canis aureus): 1-pentanol; 4-methylpentan-2-one.
Brown bear (Ursus arctos) and grizzly bear (Ursus arctos horribilis): 2,4-dimethyl-3-pentanol; 3-methylbutanoic acid; phenol, 2,2′-methylenebis(6-(1,1-dimethylethyl)-4-methyl)
Hyena (Hyaeninae family): 2-acetyl-1-pyrroline; 2,3-dihydrohexcolatol; 2-sec-butyl-4,5-dihydrothiazole.
Fox (Vulpes vulpes): Ethyl palmitate; Butyl laurate including 2,5-dimethylpyrazine, 2-phenylethylamine, and other VOCs.

Preferably for reducing fox attacks the following territorial sex pheromones are selected: 2-Phenylethyl methyl sulfide (CAS 5925-63-3) and 3-Isopentenyl methyl sulfide (CAS 5952-75-0).

### Lions:

Lions use scent marking to delineate their territories. The specific chemical compounds include 2-sec-butyl-4,5-dihydrothiazole and other VOCs.

### Tigers:

Tigers mark their territories using urine and glandular secretions.

Pheromones compounds include androstenone, androstenol, and other VOCs.

### Jaguars:

Jaguars use scent marking to communicate territorial boundaries.

Pheromone compounds involve terpenes, alkaloids, and other VOCs found in urine and secretions.

### Cougars (Mountain Lions):

Cougars mark their territories using urine and glandular secretions.

Pheromone compounds include 2-phenylethylamine and other VOCs.

### Coyotes:

Coyotes mark their territories using urine and glandular secretions.

Pheromone compounds include 2-phenylethylamine and other VOCs.

### Cheetahs:

Cheetahs use scent marking to establish and defend territories.

Pheromone compounds involve terpenes, alkaloids, and other VOCs.

### Panthers:

Panthers (which can refer to leopards or black panthers) use scent marking.

Pheromone compounds involve terpenes, alkaloids, and other VOCs.

### African Wild Dogs (Lycaons):

African wild dogs mark their territories using urine and secretions.

Pheromone compounds include 2,5-dimethylpyrazine and other VOCs.

### Domestic Dogs or Dingoes:

Domestic dogs and dingoes use scent marking to communicate territorial boundaries.

Pheromone compounds involve 2-phenylethylamine, 3-methylindole, and other VOCs.

In particular, one object of the present invention is to provide the use of a protective collar or any convenient support mean for cattle or livestock, to serve as a means of protection against possible attacks of predators of said cattle or livestock, the protective collar being incorporating at least one desired volatile odor that scatters or disperses said predators, said desired volatile odor being selected from the group consisting of specific pheromones compounds that emit odor that scatters or disperses said predators, wherein said protective collar comprises a hydrophobic matrix capable of impregnating said at least one desired volatile odor that scatters or disperses said predators said matrix further comprising antioxidants and/or ionic or non-ionic surfactants, used as emulsifiers and stabilizers, wherein said hydrophobic matrix is coated with a hydrophobic polymer for the structure and mounted on a collar or any convenient support mean to be applied to said cattle or livestock to form the protective collar, and whereas said desired volatile odor that scatters or disperses said predators are territorial sex pheromones specific to said predators' species.

According to a preferred embodiment of the invention, the hydrophobic matrix capable of impregnating said at least one desired volatile odor that scatters or disperses said predators comprises antioxidants and ionic or non-ionic surfactants.

Preferably, said cattle or livestock are farm animals selected among the group comprising sheep, cow, calf, chicken, horse, donkey, fallow, deer, ostrich, goat or humans.

According to the invention, said predators are selected from the group comprising wolves, lynx, bears, lions, tigers, jaguars, cougars, foxes, jackal, coyote, cheetah, hyena, panther, lycaons, dogs or dingo.

Advantageously, the protective collar or any convenient support mean for cattle or livestock, comprises an adjustable ring.

According to an embodiment of the invention, the hydrophobic matrix is a natural or synthetic wax selected from the group consisting of beeswax, carnauba wax, soy wax, palm wax, candelilla wax, lanolin, Montan wax, Japan wax, Paraffin, Polyethylene wax, Acetylated monoglyceride, Polyolefin wax, Polyethylene terephthalate glycol (PETG), Microcrystalline wax, Polyurethane wax or mixtures thereof.

According to another embodiment of the invention, the hydrophobic polymer coating responsible for the structure is selected from the group consisting of Polytetrafluoroethylene (PTFE), Polyethylene (PE), Polypropylene (PP), Polyvinyl chloride (PVC), Polystyrene (PS), Polycarbonate (PC), Polyethylene terephthalate (PET), Polyvinyl acetate (PVA) or mixtures thereof.

Here Applicants used the SBSE (stir bar sorptive extraction) method coupled with improved GC/MS equipment to analyze the volatile organic compounds in the urine of four canid species, gray wolf (Canis lupus), red wolf (Canis rufus), wolf-dog hybrids (Canis familiaris) and the domestic dog (Canis familiaris) in order to create working urinary profiles. The extraction method identified several compounds also seen in the urinary profiles of other large predators.

Thus according to a preferred embodiment of the invention, the predators are wolves and the desired volatile odor is a territorial sex pheromone based on wolf urinary components.

Preferably said at least one wolf's volatile odor is selected from the group consisting in acetophenone, methyl propyl sulfide, benzaldehyde and/or mixtures thereof.

Surprisingly, the addition of antioxidants such as Vitamin E, Vitamin C, β-carotene, selenium, zinc, polyphenols, Coenzyme Q10, alpha-lipidic acid and carotenoids allows prolonging the release time of the compounds and preserving the pheromone molecules from oxidative processes. These compounds can be added individually or together in a percentage between 0.05 and 10% w/w.

Preferred antioxidants are selected from the list consisting in Vitamin E, Vitamin C and carotenoids.

Advantageously, the addition of surfactants, ionic or non-ionic, used as emulsifiers, stabilizers, and surfactant agents allows better control of pheromone release. Preferably used are Span 20 (sorbitan monooleate), Span 40 (sorbitan monopalmitate), Span 60 (Sorbitan monostearate), Span 65 (sorbitan tristearate), Span 80 (sorbitan monooleate), Span 85 (sorbitan trioleate), Tween 20 (Polysorbate 20), Tween 40 (Polysorbate 40), Tween 60 (Polysorbate 60), Tween 80 (Polysorbate 80), Glycerol monoestearate. These compounds can be added individually or together in a percentage between 0.05 and 10% w/w.

Preferred surfactants are selected from the list consisting in Span 40, Span 60 and Tween 80.

Another object of the present invention is to provide a non-lethal method for cattle or livestock protection comprising the step of applying a protective collar or any convenient support mean to said cattle or livestock, to serve as a means of protection against possible attacks of predators of said cattle or livestock, the protective collar or any convenient support mean being incorporating at least one desired volatile odor that scatters or disperses said predators, said desired volatile odor being selected from the group consisting in pheromone compounds that emit odor that scatters or disperses said predators, characterized in that said protective collar or any convenient support mean comprises a hydrophobic matrix capable of impregnating said at least one desired volatile odor that scatters or disperses said predators said matrix further comprising antioxidants and/or ionic or non-ionic surfactants, used as emulsifiers and stabilizers, wherein said hydrophobic matrix is coated with a hydrophobic polymer for the structure and mounted on a collar or any convenient support mean to be applied to said cattle or livestock to form the protective collar, and whereas said desired volatile odor that scatters or disperses said predators are territorial sex pheromones specific to said predators' species.

According to a preferred embodiment of the invention, the hydrophobic matrix capable of impregnating said at least one desired volatile odor that scatters or disperses said predators comprises antioxidants and ionic or non-ionic surfactants.

Preferably, said cattle or livestock are farm animals selected among the group comprising sheep, cow, calf, chicken, horse, donkey, fallow, deer, ostrich, goat or humans.

According to an embodiment of the invention, said predators are selected from the group comprising wolves, lynx, bears, lions, tigers, jaguars, cougars, foxes, jackal, coyote, cheetah, hyena, panther, lycaons, dogs or dingo.

More preferably, the predators are wolves and the desired volatile odor is a territorial sex pheromone based on wolf urinary components.

In particular, the wolf's volatile odor is selected from the list consisting in acetophenone, methyl propyl sulfide, benzaldehyde and/or mixtures thereof.

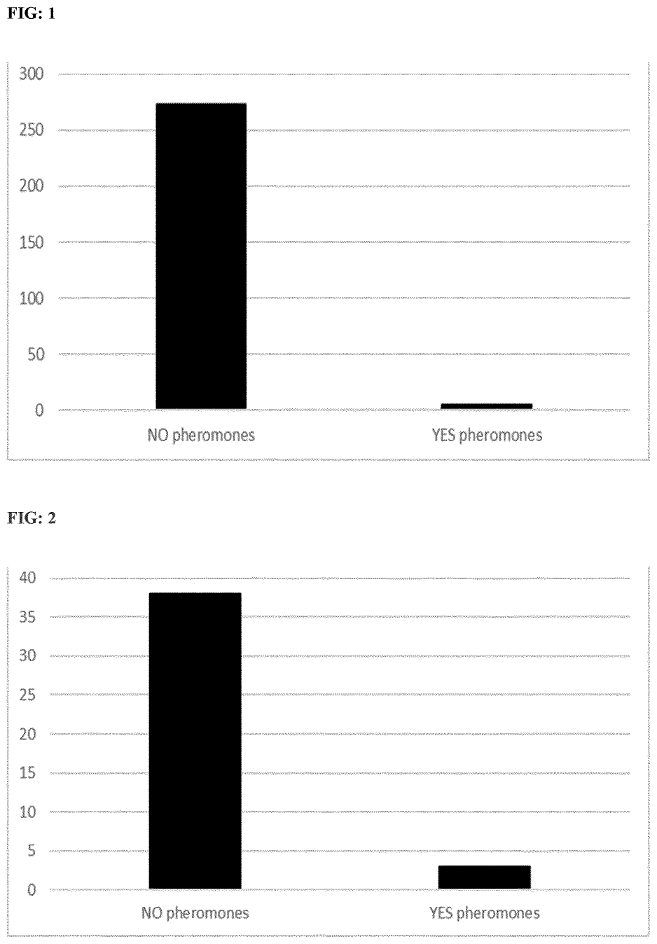

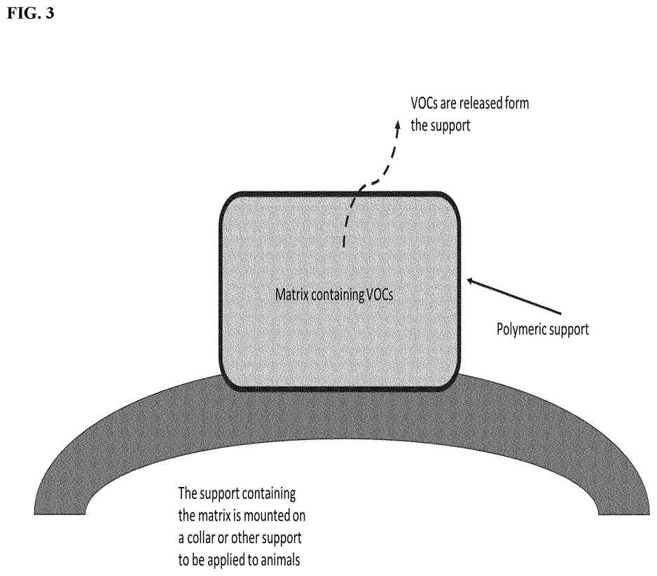

According to one embodiment of the invention, the pheromone and odor molecule delivery system consists of a hydrophobic matrix (the matrix), preferably a natural or synthetic waxes, which is impregnated with the molecules of interest (the volatile “VOC” molecules). The impregnated resin is then covered with a polymeric backing (the “structure”). The matrix in the structure is then mounted on a collar or other type of useful support to be applied to animals (FIG. 1).

According to another embodiment, natural or synthetic waxes are preferably used as the matrix.

Natural waxes are a heterogeneous group of compounds produced by plants, animals and even some microorganisms. They are composed of long-chain fatty acids, alcohols and other compounds and are used in a wide range of applications.

The following natural waxes can be used as a matrix: beeswax, carnauba wax, soy wax, palm wax, candelilla wax, lanolin, Montan wax, Japan wax or mixtures thereof.

Synthetic waxes are artificial waxes made from synthetic compounds created through chemical processes. The following synthetic waxes can be used as a matrix: Paraffin, Polyethylene wax, Acetylated monoglyceride, Polyolefin wax, Polyethylene terephthalate glycol (PETG), Microcrystalline wax, Polyurethane wax or mixtures thereof.

According to another embodiment of the invention, hydrophobic polymers are used as the polymeric backing or structure and are preferably selected from the group of polymers consisting of: Polytetrafluoroethylene (PTFE), Polyethylene (PE), Polypropylene (PP), Polyvinyl chloride (PVC), Polystyrene (PS), Polycarbonate (PC), Polyethylene terephthalate (PET) and Polyvinyl acetate (PVA) or mixtures thereof.

The combination of waxes, preferably Japanese wax, and hydrophobic polymers, preferably polyethylene, makes it possible to optimize the release of selected volatile compounds over time. Indeed, waxes are characterized by functional groups and a complex structure that allow them to strongly permeate other organic compounds. The functional groups of interest for loading a wax with the selected volatile compounds of the invention include: ester group, phenolic group, ketone group, carboxylic group, and alkyl group. By melting the wax at a defined temperature and simulated incorporation of the volatile compounds of interest, interactions between wax and volatile compounds are maximized. However, the structure of a wax is temperature-dependent, what can cause too rapid release of compounds or absorption of other compounds and weathering. Therefore, molten waxes containing the volatile compounds are embedded in another polymeric structure. The polymeric structure allows the waxes to be protected from weathering, to stabilize the permeation between wax and volatile compounds, wax and polymer, and volatile compounds and polymer. This makes it possible to slowly release VOCs compounds and make it's release more constant. It is assumed that interactions with polymers occur mainly by hydrogen and van der Waals interactions.

Surprisingly, the addition of antioxidants such as Vitamin E, Vitamin C, β-carotene, selenium, zinc, polyphenols, Coenzyme Q10, alpha-lipidic acid and carotenoids allows prolonging the release time of the compounds and preserving the pheromone molecules from oxidative processes. These compounds can be added individually or together in a percentage between 0.05 and 10% w/w.

Preferred antioxidants are selected from the list consisting in Vitamin E, Vitamin C and carotenoids.

Advantageously, the addition of surfactants, ionic or non-ionic, used as emulsifiers, stabilizers, and surfactant agents allows better control of pheromone release. Preferably used are Span 20 (sorbitan monooleate), Span 40 (sorbitan monopalmitate), Span 65 (sorbitan tristearate), Span 80 (sorbitan monooleate), Span 85 (sorbitan trioleate), Tween 20 (Polysorbate 20), Tween 40 (Polysorbate 40), Tween 60 (Polysorbate 60), Tween 80 (Polysorbate 80), Glycerol monoestearate. These compounds can be added individually or together in a percentage between 0.05 and 10% w/w.

Preferred surfactants are selected from the list consisting in Span 40, Span 60 and Tween 80.

As application structures the followings are preferably employed, such as collars made of different materials, including leather, nylon or metal; bibs made of different materials, including nylon, leather or mesh; saddles made of different materials, including nylon, leather or mesh; pack saddles made of different materials, including nylon, leather, metal or mesh; halters made of different materials, including leather, nylon or rope; bridles made of different materials, including leather, nylon or rope; or other supports to be fixed in the ground, in trees or on structures such as walls and fences. Such supports are made of a variety of materials including metal, nylon, mesh, and plastics.

Another object of the invention is to provide a protective collar for cattle or livestock, to serve as a means of protection against possible attacks of predators of said cattle or livestock, the protective collar being incorporating at least one desired volatile odor that scatters or disperses said predators, said desired volatile odor being selected from the group consisting of specific pheromone compounds that emit odor that scatters or disperses said predators, characterized in that said protective collar comprises a hydrophobic matrix capable of impregnating said at least one desired volatile odor that scatters or disperses said predators said matrix further comprising antioxidants and/or ionic or non-ionic surfactants, used as emulsifiers and stabilizers, wherein said hydrophobic matrix is coated with a hydrophobic polymer for the structure and mounted on a collar to be applied to said cattle or livestock to form the protective collar, and whereas said desired volatile odor that scatters or disperses said predators are territorial sex pheromones specific to said predators' species.

In particular the invention concerns a protective collar for cattle or livestock, designated to serve as a means of protection against possible attacks by predators, the protective collar comprises a hydrophobic matrix impregnated with at least one desired volatile odor that deters predators which is coated with a hydrophobic polymer for structural integrity, the protective collar when applied to cattle or livestock forms an effective protective barrier, characterized in that the hydrophobic matrix includes antioxidants and/or ionic/non-ionic surfactants and wherein the at least one desired volatile odor consists of territorial sex pheromones specific to the predator species.

Surprisingly, the addition of antioxidants such as Vitamin E, Vitamin C, β-carotene, selenium, zinc, polyphenols, Coenzyme Q10, alpha-lipidic acid and carotenoids allows prolonging the release time of the compounds and preserving the pheromone molecules from oxidative processes. These compounds can be added individually or together in a percentage between 0.05 and 10% w/w.

Preferred antioxidants are selected from the list consisting in Vitamin E, Vitamin C and carotenoids.

Advantageously, the addition of surfactants, ionic or non-ionic, used as emulsifiers, stabilizers, and surfactant agents allows better control of pheromone release. Preferably used are Span 20 (sorbitan monooleate), Span 40 (sorbitan monopalmitate), Span 65 (sorbitan tristearate), Span 80 (sorbitan monooleate), Span 85 (sorbitan trioleate), Tween 20 (Polysorbate 20), Tween 40 (Polysorbate 40), Tween 60 (Polysorbate 60), Tween 80 (Polysorbate 80), Glycerol monoestearate. These compounds can be added individually or together in a percentage between 0.05 and 10% w/w.

Preferred surfactants are selected from the list consisting in Span 40, Span 60 and Tween 80.

According to a preferred embodiment of the invention, the hydrophobic matrix impregnated with said at least one desired volatile odor that scatters or disperses said predators includes a mixture of antioxidants and ionic or non-ionic surfactants.

Preferably, said cattle or livestock are farm animals selected among the group comprising sheep, cow, calf, chicken, horse, donkey, fallow, deer, ostrich, goat or humans.

According to an embodiment of the invention, said predators are selected from the group comprising wolves, lynx, bears, lions, tigers, jaguars, cougars, foxes, jackal, coyote, cheetah, hyena, panther, lycaons, dogs or dingo.

More preferably, the invention concerns a protective collar for cattle or livestock, designated to serve as a means of protection against possible attacks by wolf predators, the protective collar comprises a hydrophobic matrix impregnated with at least one desired volatile odor that deters predators which is coated with a hydrophobic polymer for structural integrity, the protective collar when applied to cattle or livestock forms an effective protective barrier, characterized in that the hydrophobic matrix includes antioxidants and/or ionic/non-ionic surfactants and wherein the at least one desired volatile odor consists of territorial sex pheromones specific to wolf predators selected from the list consisting in acetophenone, methyl propyl sulfide, benzaldehyde and/or mixtures thereof.

According to a preferred embodiment of the invention, the hydrophobic matrix impregnated with said at least one desired volatile odor that scatters or disperses said wolf predators includes a mixture of antioxidants and ionic or non-ionic surfactants.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

Various references are cited throughout this specification, each of which is incorporated herein by reference in its entirety.

The foregoing description will be more fully understood with reference to the following Examples. Such Examples, are, however, exemplary of methods of practising the present invention and are not intended to limit the scope of the invention.

### EXAMPLES

### Example 1: Selection of the Volatile Molecules and Preparation of the Collars

Volatile organic chemicals have been analyzed, quantified, and characterized starting from urine of wolves from zoos or from the Laboratory of Biology for Conservation of Lausanne (Dr Luca Fumagalli) using Gas chromatography-mass spectrometry (GC-MS). Once selected the compounds deemed appropriate, have been synthesized and, at the same time Applicants elaborated the collar to apply to the domestic animals. Valid selected molecules for this study are acetophenone, methyl propyl sulphide and benzaldehyde (see Table 1) (Osada et al 2015). These molecules were found in previous studies investigating typical wolf urinary components that associated these molecules with the gender of the animal (Wolfram 2013).

TABLE 1
Volatile molecules selected for the study

| | | Vapor Pressure |
|---|---|---|
| Compounds | Boiling point (° C.) | (mmHg at 25° C.) |
| Acetophenone | 202° C. | 0.4 |
| Methyl propyl sulfide | 97° C. | 54.7 |
| Benzaldehyde | 178° C. | 1.3 |

These compounds are volatile and can be released gradually to influence animal behavior.

Two approaches have be tested to immobilize and gradually release these compounds:

### Example 2

### A) Preparation of the Coated Matrix Containing the Volatile Odor

Gently melt 50 g of Japan Wax (the “matrix”) at 60° C. for 12 h.

### Variants:

Mass of resin varying from 500 mg to 500 kg.
Temperature from 40 to 80° C.
Treatment time 2 h to 48 h

Add 2% w/v acetophenone, 2% w/v benzaldehyde and 0.5% w/v methyl propyl sulfide. Variant, for each compound: 0.05% to 5%.

Allow to cure in polypropylene-based plastic supports (the “support”): 10 g size, with variant 200 mg to 200 g.

The substrate with matrix thus obtained was applied to a custom-made collar with calfskin leather. The leather have a thickness of 0.5-10 mm (preferably from 2.0-2.4 mm) and a breadth of 5 to 1,000 mm (preferably 80 mm). The collar could be of different colors. The substrate (i.e. the collar) with matrix is placed in a special custom-made pocket attached to the collar. Also the pocket is in calfskin leather created and it is equipped with holes for pheromones to escape.

### B) Example of Alternative Preparation

Gently melt 42 g of Japan Wax and 8 g of Paraffin Wax (the “matrix”) at 60° C. for 12 h.

### Variants:

Mass of resin varying from 500 mg to 500 kg.
Ratio Japan Wax: Paraffin Wax varying from 98:2 to 70:30.
Temperature from 40 to 80° C.
Treatment time 2 h to 48 h

Add 3% w/w Vitamin E and 3% Span 60. Variant, for each compound: 0.05% to 5%.

Add 2% w/v acetophenone, 2% w/v benzaldehyde and 0.5% w/v methyl propyl sulfide. Variant, for each compound: 0.05% to 5%.

Allow to cure in polypropylene-based plastic supports (the “support”): 10 g size, with variant 200 mg to 200 g.

The resulting support (Matrix 2) is tested to evaluate the release of acetophenone, benzaldehyde, and methyl propyl sulfide over time, in comparison with a Japan Wax-only media (Matrix 1). Pheromone content in the matrix was quantified after 1, 5 and 9 weeks of exposure to air (see Table 2). Matrix 2 allows significantly longer pheromone release times, and is therefore suitable for open-field applications over long periods.

TABLE 2

| Methyl propyl sulfide | Weeks of exposure | | |
|---|---|---|---|
| Time | 1 | 5 | 9 |
| Matrix 2 | 81% | 83% | 73% |
| Matrix 1 | 76% | 40% | 9.5% |

| Benzaldehyde | weeks | | |
|---|---|---|---|
| Time | 1 | 5 | 9 |
| Matrix 2 | 84% | 95% | 95% |
| Matrix 1 | 92% | 77% | 43% |
| Acetophenone | weeks | | |
| Time | 1 | 5 | 9 |
| Matrix 2 | 86% | 87% | 96% |
| Matrix 1 | 90% | 87% | 69% |

The % remaining in the matrix of each compound after exposure is shown, 100% being the initial amount in the matrix.

### Conclusions:

The matrix according to the present invention allows for prolonged and consistent pheromone release over time, making the delivery system effective for several months. The ingredients that make up or constitute Matrix 2 allow for a more stable and reliable system in terms of release and duration, with improved pheromone release from 2× to 10× times depending on the pheromone molecule that is used.

### Example 3: Testing Phase on Wolf

The selected compounds were tested in a zoo with the presence of wolves (TierErlebnisparks Buchenberg, Austria). The wolves' enclosure has an estimated area of 1,800 to 2,000 m2. The enclosure can be divided roughly in a ratio of 1:2. This allows animals that are injured, being treated or being prepared for transport to be separated from the rest of the pack, or the entire pack can be separated if work needs to be done in the other part of the enclosure. The division of the enclosure is given by a metal fence with two openings. A smaller one of about 1 metre and a larger one of about 2.5 metres. These two openings can be closed at the discretion of the animal warden. Wolves are always fed in the same place, usually at the entrance of the fence.
1) Applicants evaluated the number of passages through the smaller door by wolves under normal conditions. The door was monitored with two camera trapping, that recorded the passage of the animals (at each pass of one wolf they took two photos). After this first 5-days monitoring the wolf are crossing the door for 257 times (see FIG. 1). This indicates a constant movement of wolves along the fence, as this was expected.
2) Applicants placed a new food place in the fence. That way is useful to later understand the use of a feeding place with the presence of pheromones. Wolves used without problem the new place of food. From the camera observing the place Applicants counted 40 visits to eat during 2 days (FIG. 2).
3) Applicants placed pheromones on the door and on the new food place. In this section Applicants wanted to understand if pheromones prevent wolves from passing the doors and if they reject food with pheromones preferring free food. Here Applicants observed a major change in behaviour. Food with pheromones was not even approached (all food was eaten by ravens). While, very interestingly, the door was crossed only 5 times on the first day (after the pheromones were applied) and always running (whereas passages without pheromones were at a trot or walking). In 5 days which represents the total duration of this test, wolves only crossed the door 5 times (see FIG. 1).
4) After 5 days it was decided to return at the normality by removing the pheromones on the door. Pheromones were left only on the new food place. Wolves have started again to cross the door without problem immediately the night after removing pheromones (in the next 5 days wolves crossed the door 289 times). Wolves preferring always eating on the food place without pheromones.
5) The last test was to remove the food place without pheromones leaving only the food place with pheromones. This test was carried out for two days. In this two days wolves didn't approach the food place and didn't eat anything (see FIG. 2). Only ravens came on the food place to eat meat.
6) After the two days Applicants did take off the pheromones on the new food place, leaving only this site of food for the next 2 days with untreated food. During this period wolves ate meat normally and visited the food place for 37 times (see FIG. 2).
7) The new place of food was removed and the initial situation was re-established.

Results of this study are presented in Table 3.

In summary:

TABLE 3

| No. of | | Pheromones | | Pheromones |
|---|---|---|---|---|
| days | What? | on the door? | Situation | on the food? |
| 5 | Door passes / | NO | Two food place | NO |
| | eating food | | | |
| 5 | Door passes / | YES | Two food place | YES |
| | eating food | | | |
| 2 | Eating food | NO | Two food place | YES |
| 2 | Eating food | NO | One food place | YES |
| 2 | Eating food | NO | One food place | NO |

### Example 4: Testing Phases on Animals

The selected animals to assess the effect of pheromones on their behavior were goats, sheep and cows. Applicants selected a farm with these animals and placed the specifically designed collar containing pheromones (as prepared in example 1) on the neck of animals. One animal per species was selected. All animals were placed in an open space with other individuals of the same species. After the first days the collar containing pheromones was applied, the animals were visually checked for the whole day. No changes in behavior was observed.

All the three species showed no stress and no change in their normal activities. Collar containing pheromones was left on each animal for 15 days without any problem in behavior.

### Example 5: Testing Phases in Real Conditions

A total of 702 animals including goats, sheep and cows were collared using the pheromone anti-wolf collars. These animals came from 25 farms, where between collared and uncollared animals, there was a total of 1532 farm animals. Most of these farms were in wolf pack territories. Comparing the predations that occurred in 2022 with those in 2023, it was observed that on the most affected farms in 2022, pet deaths were reduced by up to 80%. An animal with a pheromone collar was 2.5 times less likely to be attacked.

A detailed observation was performed on four specific farms using no protection again wolf other than pheromone anti-wolf collars, and in a region where is present a pack of 4-8 wolf.
Farm 1 (sheep): reduction of predation by 67%. In the 2022 wolf killed 40 sheep, in the 2023 using the anti-wolf collars wolf killed 13 sheep.
Farm 2 (goat): reduction of predation by 80%. In the 2022 wolf killed 24 goat, in the 2023 using the anti-wolf collars wolf killed 7 sheep.
Farm 3 (goat): reduction of predation by 89%. In the 2022 wolf killed 27 goat, in the 2023 using the anti-wolf collars wolf killed 3 goat.
Farm 4 (goat): reduction of predation by 100%. In the 2022 wolf killed 9 goat, in the 2023 using the anti-wolf collars wolf killed 0 goat.

### Example 6: Overall and Expected Reduction of Attacks on a Yearly Base (Values in % of Reduction)

The reduction in attacks was intended based on Applicant's experience in ethology, taking into account the total probability of a predator attack for a prey or human and considering the general sensitivity of different predators regarding pheromones. This is both in general terms, i.e., general sensitivity to territorial sex pheromones, and in specific terms in relation to the type of molecule proposed in the present invention. The data presented in Tables 4 and 5 are expressed in annual reduction (4 stags).

TABLE 4

| | | | | | | Jag- | | |
|---|---|---|---|---|---|---|---|---|
| | Wolves | Lynx | Bears | Lions | Tigers | uars | Cougars | Foxes |
| Humans | 80 | 20 | 80 | 50 | 50 | 50 | 50 | 20 |
| Sheep | 70 | 30 | 60 | 40 | 40 | 40 | 40 | 5 |
| Cow | 60 | 5 | 50 | 30 | 30 | 30 | 30 | 0 |
| Calf | 65 | 10 | 60 | 30 | 30 | 30 | 30 | 0 |
| Chicken | 20 | 30 | 10 | 20 | 20 | 20 | 20 | 60 |
| Horse | 40 | 5 | 50 | 40 | 40 | 40 | 40 | 0 |
| Donkey | 50 | 10 | 70 | 40 | 40 | 40 | 40 | 0 |
| Fallow | 90 | 30 | 80 | 50 | 50 | 50 | 50 | 0 |
| Deer | 90 | 30 | 80 | 50 | 50 | 50 | 50 | 0 |
| Ostrich | 65 | 10 | 60 | 40 | 40 | 40 | 40 | 10 |
| Goat | 90 | 30 | 80 | 50 | 50 | 50 | 50 | 5 |

TABLE 5

| | | Coy- | Chee- | | Pan- | | | Din- |
|---|---|---|---|---|---|---|---|---|
| | Jackal | ote | tah | Hyena | ther | Lycaon | Dogs | go |
| Humans | 50 | 70 | 50 | 50 | 50 | 50 | 10 | 60 |
| Sheep | 40 | 60 | 40 | 40 | 40 | 40 | 5 | 60 |
| Cow | 30 | 50 | 30 | 30 | 30 | 30 | 5 | 50 |
| Calf | 30 | 50 | 30 | 30 | 30 | 30 | 10 | 50 |
| Chicken | 20 | 20 | 20 | 20 | 20 | 20 | 30 | 20 |
| Horse | 40 | 60 | 40 | 40 | 40 | 40 | 20 | 60 |
| Donkey | 40 | 70 | 40 | 40 | 40 | 40 | 20 | 60 |
| Fallow | 50 | 70 | 50 | 50 | 50 | 50 | 10 | 60 |
| Deer | 50 | 70 | 50 | 50 | 50 | 50 | 10 | 60 |
| Ostrich | 30 | 60 | 40 | 40 | 40 | 40 | 10 | 50 |
| Goat | 50 | 70 | 50 | 50 | 50 | 50 | 10 | 60 |

In conclusion, based on Applicant's assessment, the system and device according to the invention is shown to be effective in particular in protecting against attacks by wolves and bears, maintains good efficacy with lions, tigers, jaguars, cougars, coyotes and panthers, and is active although somewhat less effectively against the remaining predators examined. In the case of foxes, there was a particular focus on reducing attacks on hens, being the main prey among those listed. A major reduction in fox attacks on hens is expected as a result of this system.

### Example 7: Comparison with Other Types of Support Matrices

Based on theoretical, predictive and conceptual analyses of the physical and chemical interactions between the pheromones and the media used for their release (matrix coated with the hydrophobic polymer including the surfactants and antioxidants according to the present invention), it can be concluded that the protective collar according the present invention allows for improved pheromone release by increasing the exposure time in days by at least 20% in comparison to any other type of matrix on the market (such as the protective collar for livestock disclosed in ES 1180313U). Increased exposure time means the time (in weeks) during which collars can be deployed in the field while maintaining effectiveness against predators.

### REFERENCES LIST

Anhalt, Christine M., Van Deelen, Timothy R., Schultz, Ronald N., and Wydeven, Adrian P. Effectiveness of a Simulated Pack to Manipulate Wolf Movements, 2014, Human-Wildlife Interactions: Vol. 8: Iss. 2, Article 6.
Ausband, David E., Michael S. Mitchell, Sarah B. Bassing, and Craig White. No Trespassing: Using a Biofence to Manipulate Wolf Movements, 2013, Wildlife Research 40, n. 3:207.
Bryan H. M., Smits J. E. G., Koren L., Paquet P. C., Wynne-Edwards K. E., Musiani M.; Heavily hunted wolves have higher stress and reproductive steroids than wolves with lower hunting pressure, 2015, Functional Ecology.
Chen Y., Chen X., Chen Y., Wei H., Lin S., Tian H., Lin T., Zhao J. and Gu X., Preparation, characterisation, and controlled release of sex pheromone-loaded MPEG-PCL diblock copolymer micelles for Spodoptera litura (Lepidoptera: Noctuidae), 2018, PLOS ONE 13(9): e0203062.
Federal Office for the Environment, Aide à l'exécution de l'Office federal de l'environment relative à la gestion du loup en Suisse, 2016.
Karlson P., Lüscher M.; “Pheromones”: a new term for a class of biologically active substances, 1959, Nature.
Kong X. Z., Gu X., Zhu X. and Zhang Z., Spreadable dispersion of insect sex pheromone capsules, preparation via complex coacervation and release control of the encapsulated pheromone component molecule, 2009, Biomedical Micro devices 11(1): 275-285.
Louvrier J., Duchamp V., Lauret V., Marboutin E., Cubaynes S., Choquet R., Miquel C., Gimenez O.; Mapping and explaining wolf recolonization in France using dynamic occupancy models and opportunistic data, 2018, Ecography.
Omi S., Umeki N., Mohri H. and Iso M., Microencapsulation of pheromone-analogue and measurement of the sustained release, 1991, Journal of Microencapsulation 8(4): 465-478.
Osada S. J. K., Miyazono S., and Kashiwayanagi M.; The scent of wolves: pyrazine analogs induce avoidance and vigilance behaviors in prey, 2015, Frontiers in neuroscience 9:363-363.
Shivik J. A., Treves A., Callahan P.; Nonlethal techniques for managing predation: primary and secondary repellents, 2003, USDA National Wildlife Research Center-Staff Publications.
Sikder A., Pearce A. K., Parkinson, Napier R. and O'Reilly R. K.; Recent Trends in Advanced Polymer Materials in Agriculture Related Applications, 2021, ACS Applied Polymer Materials 3(3): 1203-1217.
Valière N., Fumagalli L., Gielly L., Miquel C., Lequette B., Poulle M. L., Weber J. M., Arlettaz R., Taberlet P.; Long-distance wolf recolonization of France and Switzerland inferred from non-invasive genetic sampling over a period of 10 years, 2003, Animal Conservation.
Wolfram W.; Scent-marking: investigating chemosensory signals in wolf urine, 2013, Thesis.

1. A protective collar or any convenient support for cattle or livestock, for protection against possible attacks of predators of said cattle or livestock, the protective collar incorporating at least one desired volatile odor that scatters or disperses said predators, said desired volatile odor being selected from the group consisting of specific pheromone compounds that emit odor that scatters or disperses said predators, wherein said protective collar comprises a hydrophobic matrix impregnated with said at least one desired volatile odor that scatters or disperses said predators, said hydrophobic matrix further comprising at least one of antioxidants and ionic or non-ionic surfactants, used as emulsifiers and stabilizers, wherein said hydrophobic matrix is coated with a hydrophobic polymer and mounted on the protective collar or the convenient support to be applied to said cattle or livestock to form the protective collar, and whereas said desired volatile odor that scatters or disperses said predators are territorial sex pheromones specific to species of said predators.

2. The collar of claim 1, wherein said cattle or livestock are farm animals selected among the group comprising sheep, cow, calf, chicken, horse, donkey, fallow, deer, ostrich, goat, or humans.

3. The collar of claim 1, wherein said predators are selected from the group comprising wolves, lynx, bears, lions, tigers, jaguars, cougars, foxes, jackal, coyote, cheetah, hyena, panther, lycaons, dogs, or dingo.

4. The collar of claim 1, wherein the collar comprises an adjustable ring.

5. A hydrophobic matrix comprising a wax impregnated with at least one desired volatile odor that scatters or disperses predators, wherein the desired volatile odor contains methyl propyl sulphide.

6. The hydrophobic matrix of claim 5, wherein the volatile odor contains at least one of acetophenone and benzaldehyde.

7. The hydrophobic matrix of claim 5, wherein the volatile odor is present in a range of 0.05% up to and including 5% w/w.

8. (canceled)

9. The hydrophobic matrix of claim 5, wherein the predators are wolves and the desired volatile odor is a territorial sex pheromone based on wolf urinary components.

10. The hydrophobic matrix of claim 9, wherein the wolf's territorial sex pheromone is selected from the group consisting of acetophenone, methyl propyl sulfide, benzaldehyde, and/or mixtures thereof.

11. A non-lethal method for cattle or livestock protection comprising the step of applying a protective collar or any convenient support to said cattle or livestock, for protection against possible attacks of predators of said cattle or livestock, the protective collar or the convenient support being incorporating at least one desired volatile odor that scatters or disperses said predators, said desired volatile odor being selected from the group consisting of pheromone compounds that emit odor that scatters or disperses said predators, wherein said protective collar or said convenient support comprises a hydrophobic matrix impregnated with said at least one desired volatile odor that scatters or disperses said predators, said hydrophobic matrix further comprising at least one of an antioxidant and an ionic or non-ionic surfactant, used as an emulsifier and stabilizer, wherein said hydrophobic matrix is coated with a hydrophobic polymer and mounted on the protective collar or the convenient support to be applied to said cattle or livestock to form the protective collar, and whereas said desired volatile odor that scatters or disperses said predators are territorial sex pheromones specific to species of said predators.

12. The non-lethal method of claim 11, wherein said cattle or livestock are farm animals selected among the group comprising sheep, cow, calf, chicken, horse, donkey, fallow, deer, ostrich, goat, or humans.

13. The non-lethal method of claim 11, wherein said predators are selected from the group comprising wolves, lynx, bears, lions, tigers, jaguars, cougars, foxes, jackal, coyote, cheetah, hyena, panther, lycaons, dogs, or dingo.

14. The non-lethal method, of claim 11, wherein the predators are wolves and the desired volatile odor is a territorial sex pheromone based on wolf urinary components.

15. The non-lethal method of claim 14, wherein the wolf's territorial sex pheromone is selected from a list consisting of acetophenone, methyl propyl sulfide, benzaldehyde, and/or mixtures thereof.

16. The non-lethal method of claim 11, wherein said antioxidants are selected from the group comprising Vitamin E, Vitamin C, β-carotene, selenium, zinc, polyphenols, Coenzyme Q10, alpha-lipidic acid, carotenoids, or a mixture thereof in a percentage between 0.05 and 10% w/w.

17. The non-lethal method of claim 11, wherein said ionic or non-ionic surfactants are selected from the group comprising Span 20 (sorbitan monooleate), Span 40 (sorbitan monopalmitate), Span 65 (sorbitan tristearate), Span 80 (sorbitan monooleate), Span 85 (sorbitan trioleate), Tween 20 (Polysorbate 20), Tween 40 (Polysorbate 40), Tween 60 (Polysorbate 60), Tween 80 (Polysorbate 80), Glycerol monostearate, or a mixture thereof in a percentage between 0.05 and 10% w/w.

18. (canceled)

19. (canceled)

20. The hydrophobic matrix of claim 5, wherein the wax is a natural or synthetic wax selected from the group consisting of beeswax, carnauba wax, soy wax, palm wax, candelilla wax, lanolin, Montan wax, Japan wax, Paraffin, Polyethylene wax, Acetylated monoglyceride, Polyolefin wax, Polyethylene terephthalate glycol (PETG), Microcrystalline wax, Polyurethane wax or mixtures thereof.

21. The hydrophobic matrix of claim 5, wherein the hydrophobic matrix is coated with a hydrophobic polymer, wherein the hydrophobic polymer can be selected from the group consisting of Polytetrafluoroethylene (PTFE), Polyethylene (PE), Polypropylene (PP), Polyvinyl chloride (PVC), Polystyrene (PS), Polycarbonate (PC), Polyethylene terephthalate (PET), Polyvinyl acetate (PVA), or mixtures thereof.

22. The hydrophobic matrix of claim 5, wherein the hydrophobic matrix comprises at least one of an antioxidant and a ionic or non-ionic surfactant.

23. The hydrophobic matrix of claim 22, wherein the antioxidant is selected from the group comprising Vitamin E, Vitamin C, β-carotene, selenium, zinc, polyphenols, Coenzyme Q10, alpha-lipidic acid, carotenoids, or a mixture thereof.

24. The hydrophobic matrix of claim 22, wherein the ionic or non-ionic surfactant is selected from the group comprising Span 20 (sorbitan monooleate), Span 40 (sorbitan monopalmitate), Span 65 (sorbitan tristearate), Span 80 (sorbitan monooleate), Span 85 (sorbitan trioleate), Tween 20 (Polysorbate 20), Tween 40 (Polysorbate 40), Tween 60 (Polysorbate 60), Tween 80 (Polysorbate 80), Glycerol monostearate, or a mixture thereof.
